(19) United States
(12) Patent Application Publication
(10) Pub. No.: US 2012/0316064 A1
(43) Pub. Date: Dec. 13, 2012

(54) TREATMENT APPLICATOR

(76) Inventor: John P. Ruckart, Atlanta, GA (US)

(21) Appl. No.: 13/158,749

(22) Filed: Jun. 13, 2011

(51) Int. Cl. A01N 25/08; A01P 13/00; A01G 1/00; A01N 25/34

(52) U.S. Cl. 504/116.1; 424/409; 47/1.5

(57) ABSTRACT

A fluid application apparatus is disclosed having adhesive compositions and controlled release compositions for applying treatments such as pesticides, herbicides, and fertilizers, to target plants, and the like. In at least one embodiment, the application apparatus includes a treatment release device adapted to release a pesticide, herbicide, fertilizer, or the like, for adhesion to and treatment of a target plant, the release device comprising: a substrate; a quantity of media adapted to contain a controlled release composition disposed upon the substrate and adapted to release the controlled release composition to a target plant for treatment; and an adhesive composition disposed upon the substrate and adapted to adhere the treatment release device and the quantity of media adapted to contain a controlled release composition to the target plant for treatment.

### FIELD OF THE INVENTION

The technology described herein relates generally to the fields of applicators, adhesive compositions, and controlled release compositions. More specifically, this technology relates to a fluid application apparatus and associated methods for applying treatments such as pesticides, herbicides, and fertilizers, to target plants, and the like.

### BACKGROUND OF THE INVENTION

Pesticides, herbicides, and fertilizers are well known in the art to apply to lawns, trees, plants, and the like, to provide nutrients and prevent or reduce weeds, for example. An Applicator is used to apply a pesticide, herbicide, fertilizer or like substance to plants, lawns, weeds, grass, vines, trees, and so forth.

Related patents known in the art include the following: U.S. Pat. No. 6,903,053, issued to Noda et al. on Jun. 7, 2005, discloses agricultural items and agricultural methods comprising biodegradable copolymers. U.S. Pat. No. 4,111,684, issued to Thomas et al. on Sep. 5, 1978, discloses herbicide-filled cellulose ester particles having controlled release properties. U.S. Pat. No. 4,898,920 issued to Lee et al. on Feb. 6, 1990, discloses adhesive compositions, controlled release compositions, and a transdermal delivery device. U.S. Pat. No. 6,338,296, issued to Forsythe et al. on Jan. 15, 2002, discloses a release device for slowly releasing sprout inhibitor into packages for potatoes. U.S. Pat. No. 4,882,874, issued to Paulson et al. on Nov. 28, 1989, discloses a pesticide applicator. U.S. Pat. No. 5,216,833, issued to Longer on Jun. 8, 1993, discloses an herbicide applicator. U.S. Pat. No. 6,367,714, issued to Smoot on Apr. 9, 2002, discloses a weed stick spray. U.S. Pat. No. 4,803,801, issued to Nelson, Jr. on Feb. 14, 1989, discloses a weedeater. U.S. Pat. No. 5,329,727, issued to Dixon on Jul. 19, 1994, discloses a topical herbal treatment applicator. U.S. Pat. No. 6,123,478, issued to Giles on Sep. 26, 2000, discloses fluid applicator. U.S. Pat. No. 7,213,997, issued to Joyner on May 8, 2007, discloses an herbicide applicator. Related non-patent information known in the art includes the “WeedBall” by Garden Weasel®, found online at www.weedball.com.

The foregoing patent and other information reflect the state of the art of which the inventor is aware and are tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

In various exemplary embodiments, the technology described herein provides an application apparatus having adhesive compositions and controlled release compositions and associated methods for applying treatments such as pesticides, herbicides, and fertilizers, to target plants, and the like.

In one exemplary embodiment, the technology described herein provides a treatment release device adapted to release a pesticide, herbicide, fertilizer, or the like, for adhesion to and treatment of a target plant. The release device includes: a substrate; and a quantity of media adapted to contain a controlled release composition disposed upon the substrate and adapted to release the controlled release composition to a target plant for treatment.

The release device also can include an adhesive composition disposed upon the substrate and adapted to adhere the treatment release device and the quantity of media adapted to contain a controlled release composition to the target plant for treatment.

In at least one embodiment, the substrate of the treatment release device is a tape adapted to be dispensed from a dispenser and applied to a target plant for treatment.

In at least one embodiment, the substrate of the treatment release device includes a plurality of pre-cut patches adapted to be dispensed from a dispenser and applied to a target plant for treatment.

In at least one embodiment, the substrate of the treatment release device includes a clamshell housing within which the quantity of media adapted to contain a controlled release composition is disposed.

The quantity of media adapted to contain the controlled release composition can be an absorbent material.

The quantity of media adapted to contain the controlled release composition can be a non-permeable material.

The quantity of media adapted to contain the controlled release composition can be a non-permeable material that is waterproof.

In at least one embodiment, the quantity of media adapted to contain a controlled release composition is disposed longitudinally upon a central area the substrate. Additionally, the adhesive composition is disposed longitudinally upon the substrate on one or more sides of the quantity of media, thereby adapted to provide adhesion to adhere the treatment release device and the quantity of media adapted to contain a controlled release composition to the target plant for treatment.

The controlled release composition can include an herbicide, fertilizer, pesticide, or like product for application to a plant.

In at least one embodiment, the substrate further includes an identification color adapted to identify on the target plant an area to which the treatment release device has been applied.

In another exemplary embodiment, the technology described herein provides an applicator for applying treatments such as pesticides, herbicides, and fertilizers, to target plants, and the like. The applicator includes: a dispenser; a treatment release device having a substrate, the treatment release device adapted to be dispensed by the dispenser and to release a pesticide, herbicide, fertilizer, or the like, for adhesion to and treatment of a target plant; and a quantity of media adapted to contain a controlled release composition disposed upon the substrate and adapted to release the controlled release composition to a target plant for treatment.

The applicator can also includes a treatment release device having an adhesive composition disposed upon the substrate and adapted to adhere the treatment release device and the quantity of media adapted to contain a controlled release composition to the target plant for treatment.

In at least one embodiment of the applicator, the substrate comprises a tape adapted to be dispensed from the dispenser and applied to a target plant for treatment; and wherein the dispenser comprises a tape dispenser.

In at least one embodiment of the applicator, the substrate comprises a plurality of pre-cut patches adapted to be dispensed from a dispenser and applied to a target plant for treatment; and wherein the dispenser comprises a dispenser of pre-cut patches.

In at least one embodiment of the applicator, the substrate comprises a clamshell housing within which the quantity of media adapted to contain a controlled release composition is disposed.

In yet another exemplary embodiment, the technology described herein provides a method for applying treatments such as pesticides, herbicides, and fertilizers to target plants, and the like. The method includes: utilizing an applicator for applying treatments such as pesticides, herbicides, and fertilizers, to target plants, and the like, the applicator comprising: a dispenser; a treatment release device having a substrate, the treatment release device adapted to be dispensed by the dispenser and to release a pesticide, herbicide, fertilizer, or the like, for adhesion to and treatment of a target plant; and a quantity of media adapted to contain a controlled release composition disposed upon the substrate and adapted to release the controlled release composition to a target plant for treatment; and dispensing the controlled release composition from the dispenser to the target plant for treatment.

The method also can include: utilizing an applicator further comprising: an adhesive composition disposed upon the substrate and adapted to adhere the treatment release device and the quantity of media adapted to contain a controlled release composition to the target plant for treatment; and adhering the treatment release device and the quantity of media adapted to contain the controlled release composition to the target plant for treatment.

In at least one embodiment of the method, the substrate comprises one selected from the group consisting of: a tape adapted to be dispensed from a dispenser and applied to a target plant for treatment, a plurality of pre-cut patches adapted to be dispensed from a dispenser and applied to a target plant for treatment, and a clamshell housing within which the quantity of media adapted to contain a controlled release composition is disposed.

Advantageously, the technology described herein provides a treatment release device, several applicators for applying the treatment release devices, and associated methods for applying the treatment release device to a target plant, or the like, that, for example, enable less frequent application on stubborn weeds, provide a barrier between pesticides and children and pets, and require less pesticide product. Additionally, the technology described herein provides an ergonomic dispenser. Furthermore, the technology described herein provides for pesticide applications that will not runoff due to wind, rain, and other weather elements.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a top planar view of an adhesive dispenser apparatus having an adhesive composition and a controlled release composition such as a pesticide, herbicide, or fertilizer to be dispensed, disposed thereon, according to an embodiment of the invention;

FIG. 2 is a front perspective view of an applicator for applying treatments such as pesticides, herbicides, and fertilizers, to target plants, and the like, with the adhesive dispenser apparatus depicted in FIG. 1, according to an embodiment of the invention;

FIG. 3 is a front perspective view of the applicator depicted in FIG. 2, illustrating, in particular, a modified extendible stem and ergonomic handle, according to an embodiment of the invention;

FIG. 4 is a front perspective view an adhesive dispenser apparatus having an adhesive composition and a controlled release composition such as a pesticide, herbicide, or fertilizer to be dispensed, disposed thereon, according to an alternative embodiment of the invention;

FIG. 5 is a front perspective view of an applicator for applying treatments such as pesticides, herbicides, and fertilizers, to target plants, and the like, with adhesive dispenser apparatus depicted in FIG. 4, according to an alternative embodiment of the invention;

FIG. 6 is a front perspective view the applicator depicted in FIG. 2 shown is use in application to a base of a tree; and

FIG. 7 is a front perspective view the applicator depicted in FIG. 2 shown is use in application to a vine, such as poison ivy.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides an application apparatus having adhesive compositions and controlled release compositions. The technology described herein further provides associated methods for applying treatments such as pesticides, herbicides, and fertilizers, to target plants, and the like.

Pesticides, herbicides, and fertilizers are well known in the art to apply to lawns, trees, plants, and the like, to provide nutrients and prevent or reduce weeds, for example. However, known products for application typically apply pesticides too broadly and only in the general area of a target plant. Typically, pesticides, herbicides, and fertilizers are dispensed in spray, foam or granular forms, each of which can include much inefficiency and other shortcomings. By way of example, application typically includes too much pesticide, or overspray. Overspray can harm non-target plants and can be dangerous for children and pets. Also, by way of example, rain and wind can dilute the effectiveness of an applied pesticide. Furthermore, a diluted pesticide may require multiple applications for stubborn target plants such as poison ivy, dandelions, and so forth. It is also known that pesticides or the like are applied with a spray bottle. Application of such over a large area can be physically tiring to the user. Once pesticides or the like are applied, there is usually no indication that there is risk of exposure. The technology described herein overcomes this inefficiencies and shortcomings.

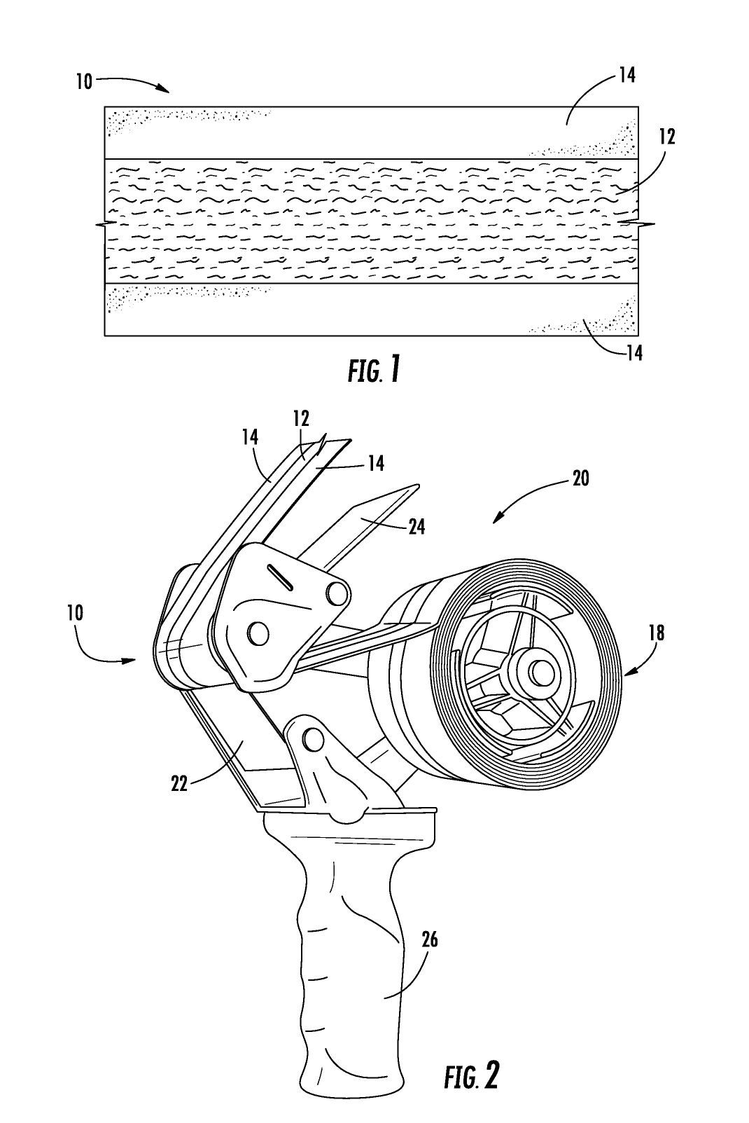

Referring now to FIG. 1, an adhesive dispenser apparatus, a treatment release device 10, having an adhesive composition 14 and a controlled release composition 12 such as a pesticide, herbicide, or fertilizer to be dispensed, disposed thereon is shown.

This treatment release device 10 is adapted to release a pesticide, herbicide, fertilizer, or the like, for adhesion to and treatment of a target plant. The treatment release device 10 is a substrate upon which other materials are applied either to assist with adhesion or to later be dispensed from the substrate.

In at least one embodiment, the controlled release composition 12, such as a pesticide, herbicide, or fertilizer, is contained in a quantity of media adapted to contain the controlled release composition 12 disposed upon the substrate 10 and adapted to release the controlled release composition 12 to a target plant for treatment.

The media selected to contain the pesticide, herbicide, or fertilizer is preferably an absorbent material. Additionally, the media selected is preferably a non-permeable material. Furthermore, the media selected is preferably waterproof. Media that provide time release or controlled release are known in the art. By way of example, U.S. Pat. No. 4,898,920 discloses the use of silicone polymers and resinous copolymers. U.S. Pat. No. 6,903,053 discloses biodegradable copolymers. U.S. Pat. No. 4,111,684 discloses herbicide-filled cellulose esters having controlled release properties. Any one or more of these, or like compositions, can be utilized on the substrate 10 disclosed herein in order to apply a treatment such as a pesticide, herbicide, or fertilizer to a target plants.

In at least one embodiment, the controlled release composition 12 disposed upon the substrate 10 is Round Up® brand weed and grass killer Additionally, other known, commercially available weed killers such as EcoSmart® and Remuda® brands, and the like, are utilized in alternative embodiments.

In at least one embodiment, the controlled release composition 12 disposed upon the substrate 10 is acetic acid, or a compound containing acetic acid. Acetic acid is an organic carboxylic acid, probably most known for giving vinegar its taste and smell. Vinegar, typically four to eighteen percent acetic acid, is known to kill weeds. This provides an organic solution to weed control. Additionally, acetic acid or vinegar can be combined with other additives to vary a compound for the controlled release composition 12.

Additionally, in at least one embodiment, the controlled release composition 12 disposed upon the substrate 10 is citric acid, or a compound containing citric acid. Similar to acetic acid, citric acid known to kill weeds. Furthermore, combinations of acetic acid and citric acid can be used for the controlled release composition 12.

Furthermore, in at least one embodiment, the controlled release composition 12 disposed upon the substrate 10 is fish oil, or a compound containing fish oil. Fish oil is known to kills weeds. This provides yet another organic solution to weed control using fish oil as the controlled release composition 12.

The treatment release device 10 includes an adhesive composition 14 disposed upon the substrate and adapted to adhere the treatment release device 10 and the quantity of media adapted to contain a controlled release composition 12 to the target plant for treatment. Adhesive compositions are known in the art. The adhesive composition 14 for use with the treatment release device 10 is preferably a composition that adheres were to plants and to itself when wrapped entirely around a plant.

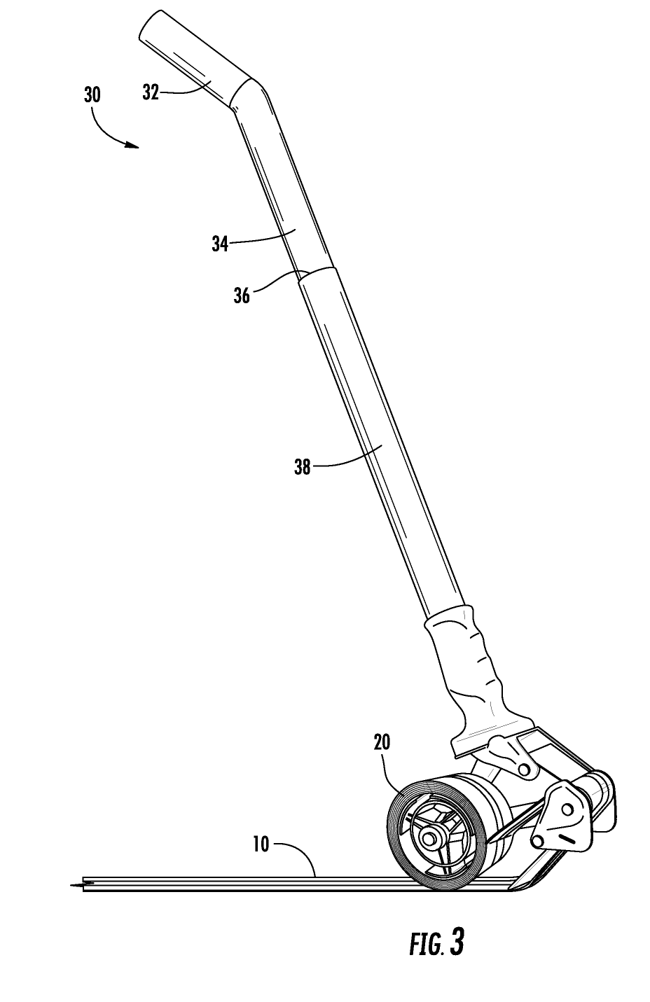

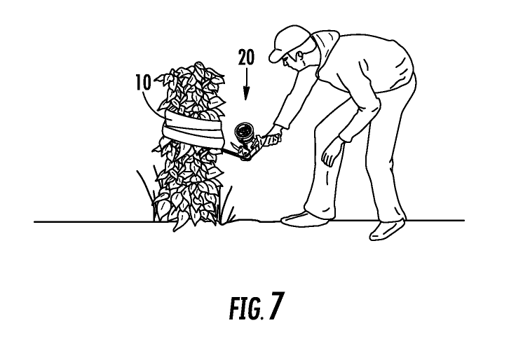

In at least one embodiment, the substrate of the treatment release device 10 is a tape (as depicted in FIG. 1) adapted to be dispensed from a dispenser (as depicted in FIG. 2, for example) and applied to a target plant for treatment (as depicted in FIG. 6, for example).

In at least one embodiment, the quantity of media adapted to contain a controlled release composition 12 is disposed longitudinally upon a central area the substrate 10. Additionally, the adhesive composition 14 is disposed longitudinally upon the substrate 10 on one or more sides of the quantity of media. As such, the device is thereby adapted to provide adhesion to adhere the treatment release device 10 and the quantity of media adapted to contain a controlled release composition 12 to the target plant for treatment.

In at least one embodiment, the substrate 10 further includes an identification color adapted to identify on the target plant an area to which the treatment release device has been applied. By way of example, utilization of a highly-visible, colored and/or patterned tape provides a visual indicator of where pesticide has been applied.

Referring now to FIG. 2, an applicator 20 for applying treatments such as pesticides, herbicides, and fertilizers, to target plants, and the like, with the adhesive dispenser apparatus depicted in FIG. 1, is shown. The substrate of the treatment release device 10 is a tape shown in a tape reel 18 that is dispensed from the applicator 20.

This tape applicator embodiment provides a user with the ability to allow the tape 10, controlled release composition 12, and adhesive composition 14 to be wrapped around the stem, branch, or leaf of the target plant. By way of example, and as depicted in FIG. 6, the tape 10, controlled release composition 12, and adhesive composition 14 are wrapped around the base of a tree. The tape 10 can be adhered to itself once wrapped around a tree (as depicted in FIG. 6) or like plant or vine (as depicted in FIG. 7).

The tape applicator 20 includes an ergonomic handle 26 to provide ease of use in application of the controlled release composition 12. The tape applicator 20 includes a guide 22 to keep the tape 10 properly dispensed from the tape reel 20 to the tensioner 24. The tensioner 24 provides a tension on the tape 10 when applied by the use of the tape applicator 20.

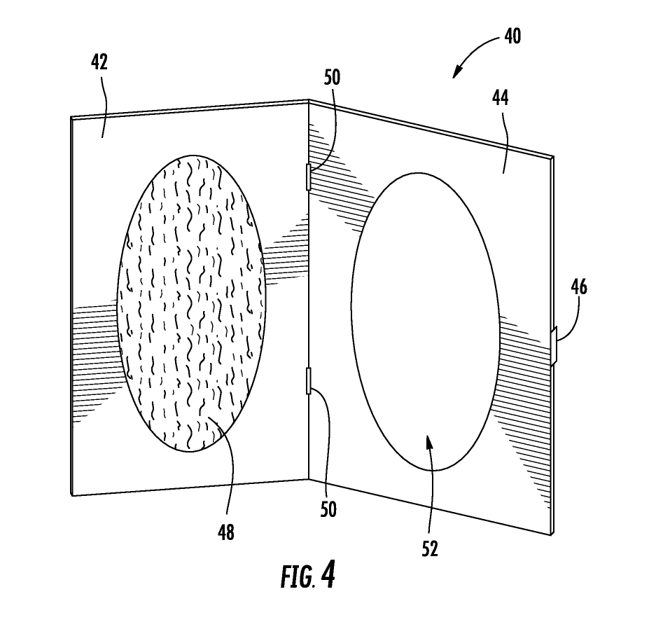

Referring now to FIG. 3, an alternative embodiment of the tape applicator 30 is shown. The tape applicator 30 includes a modified extendible stem and ergonomic handle. The tape applicator 30 is configured to have an adjustable length. The tape applicator 30 includes hand grip 32 and extendible arm having, for example, a lower arm portion 38 and an upper arm portion 34 telescoping at joint 36. Variations of the extendible stem and ergonomic handle are contemplated such that the user of the tape applicator 30 is utilized at a distance, such as to the ground, or to an overhead area, or hard-to-reach area.

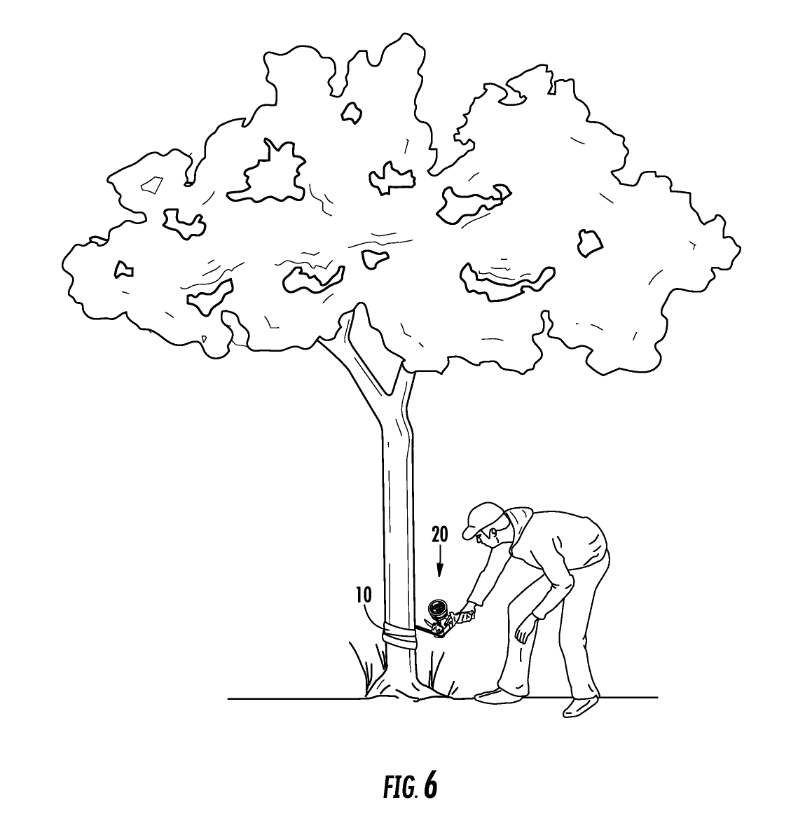

In at least one alternative embodiment, the substrate of the treatment release device 10 includes a plurality of pre-cut patches (10 in FIG. 5) adapted to be dispensed from a dispenser 60 and applied to a target plant for treatment. As depicted specifically in FIG. 5, for example, the pre-cut patches 10 are shown on a reel in applicator 60, similar to a pricing gun or label gun. The pre-cut patches 10 contain the controlled release composition 12 and adhesive composition 14 as disclosed previously. The pre-cut patches 10 are dispensed, for example, at area 62 for application to a plant.

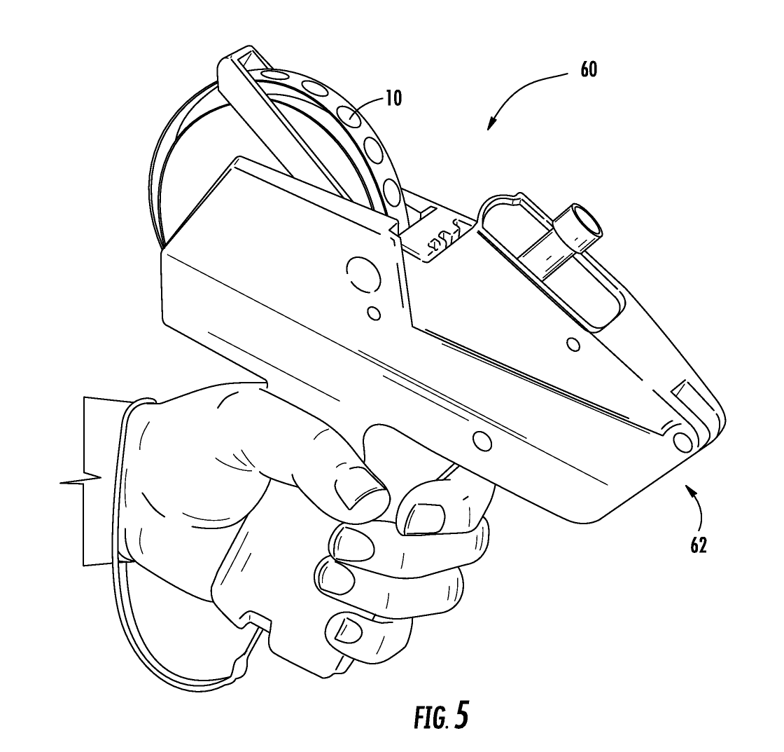

Referring now to FIG. 4, in at least one alternative embodiment, the substrate of the treatment release device 10 includes a clamshell housing 40 within which the quantity of media adapted to contain a controlled release composition 48 is disposed. The clamshell housing 40 provides an entry and exit port for a branch, or like plant or vine, to be treated with the controlled release composition 48. The clamshell housing 40 can further include punch out tabs for the entry and exits ports. By way of example, tabs could be ⅛″, ¼″, ½″, and so forth. The controlled release composition 48 can be manufactured of a flexible plastic material, for example, such that is provides flexibility in coupling to a plant, limb, or vine. In at least one embodiment, flexibility of the clamshell housing 40 is furthered by the use of a perforation.

The controlled release composition 48, as disclosed above with regard to the tape applicator, can include Round Up® or like commercial weed and grass killer, acetic acid, citric acid, fish oil, and so forth.

The clamshell housing 40 is manufactured of plastic bio-degradable, paper, cardboard, and other substantially waterproof materials in various embodiments.

The clamshell housing 40 operates like a “clamshell” in that is has a first side 42 and second side 44 that can be closed around a plant stem or branch, or the like, and closed. The first side 42 and the second side 44 are hingedly coupled to one another with at least one hinge 50 in one embodiment. The first side 42 and the second side 44 are secured one to another after surrounding a plant stem or branch, or the like, with closure device 46 in at least one embodiment. Area 48 includes a controlled release composition 12. Area 52 can also include a controlled release composition 12 in at least one embodiment. The clamshell housing 40 be made of a highly-visible color and/or pattern that can serve as a visual indicator as to where pesticide has been applied.

In yet another exemplary embodiment, the technology described herein provides a method for applying treatments such as pesticides, herbicides, and fertilizers to target plants, and the like. The method includes: utilizing an applicator for applying treatments such as pesticides, herbicides, and fertilizers, to target plants, and the like. The applicator includes: a dispenser 20, 30, 40, 60; a treatment release device 10 having a substrate, the treatment release device 10 adapted to be dispensed by the dispenser 20, 30, 40, 60 and to release a pesticide, herbicide, fertilizer, or the like, for adhesion to and treatment of a target plant; and a quantity of media adapted to contain a controlled release composition 12 disposed upon the substrate and adapted to release the controlled release composition to a target plant for treatment; and dispensing the controlled release composition 12 from the dispenser to the target plant for treatment.

The method also can include: utilizing an applicator further comprising: an adhesive composition 14 disposed upon the substrate 10 and adapted to adhere the treatment release device and the quantity of media adapted to contain a controlled release composition 12 to the target plant for treatment; and adhering the treatment release device and the quantity of media adapted to contain the controlled release composition 12 to the target plant for treatment.

In at least one embodiment of the method, the substrate 10 comprises one selected from the group consisting of: a tape adapted to be dispensed from a dispenser 20, 30 and applied to a target plant for treatment, a plurality of pre-cut patches adapted to be dispensed from a dispenser 60 and applied to a target plant for treatment, and a clamshell housing 40 within which the quantity of media adapted to contain a controlled release composition 12 is disposed.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A treatment release device adapted to release a pesticide, herbicide, fertilizer, or the like, for adhesion to and treatment of a target plant, the release device comprising:
a substrate; and
a quantity of media adapted to contain a controlled release composition disposed upon the substrate and adapted to release the controlled release composition to a target plant for treatment.

2. The treatment release device of claim 1, further comprising:
an adhesive composition disposed upon the substrate and adapted to adhere the treatment release device and the quantity of media adapted to contain a controlled release composition to the target plant for treatment.

3. The treatment release device of claim 1, wherein the substrate comprises a tape adapted to be dispensed from a dispenser and applied to a target plant for treatment.

4. The treatment release device of claim 1, wherein the substrate comprises a plurality of pre-cut patches adapted to be dispensed from a dispenser and applied to a target plant for treatment.

5. The treatment release device of claim 1, wherein the substrate comprises a clamshell housing within which the quantity of media adapted to contain a controlled release composition is disposed.

6. The treatment release device of claim 1, wherein the quantity of media adapted to contain the controlled release composition comprises an absorbent material.

7. The treatment release device of claim 1, wherein the quantity of media adapted to contain the controlled release composition comprises a non-permeable material.

8. The treatment release device of claim 1, wherein the quantity of media adapted to contain the controlled release composition comprises a non-permeable material that is waterproof.

9. The treatment release device of claim 2, wherein the quantity of media adapted to contain a controlled release composition is disposed longitudinally upon a central area the substrate, and wherein the adhesive composition is disposed longitudinally upon the substrate on one or more sides of the quantity of media, thereby adapted to provide adhesion to adhere the treatment release device and the quantity of media adapted to contain a controlled release composition to the target plant for treatment.

10. The treatment release device of claim 1, wherein the controlled release composition is an herbicide.

11. The treatment release device of claim 1, wherein the controlled release composition is a fertilizer.

12. The treatment release device of claim 1, wherein the controlled release composition is a pesticide.

13. The treatment release device of claim 1, wherein the substrate further comprises an identification color adapted to identify on the target plant an area to which the treatment release device has been applied.

14. An applicator for applying treatments such as pesticides, herbicides, and fertilizers, to target plants, and the like, the applicator comprising:
a dispenser;
a treatment release device having a substrate, the treatment release device adapted to be dispensed by the dispenser and to release a pesticide, herbicide, fertilizer, or the like, for adhesion to and treatment of a target plant; and
a quantity of media adapted to contain a controlled release composition disposed upon the substrate and adapted to release the controlled release composition to a target plant for treatment.

15. The applicator of claim 14, further comprising:
an adhesive composition disposed upon the substrate and adapted to adhere the treatment release device and the quantity of media adapted to contain a controlled release composition to the target plant for treatment.

16. The applicator of claim 14, wherein the substrate comprises a tape adapted to be dispensed from the dispenser and applied to a target plant for treatment; and wherein the dispenser comprises a tape dispenser.

17. The applicator of claim 14, wherein the substrate comprises a plurality of pre-cut patches adapted to be dispensed from a dispenser and applied to a target plant for treatment; and wherein the dispenser comprises a dispenser of pre-cut patches.

18. The applicator of claim 14, wherein the substrate comprises a clamshell housing within which the quantity of media adapted to contain a controlled release composition is disposed.

19. A method for applying treatments such as pesticides, herbicides, and fertilizers to target plants, and the like, the method comprising:
utilizing an applicator for applying treatments such as pesticides, herbicides, and fertilizers, to target plants, and the like, the applicator comprising:
a dispenser;
a treatment release device having a substrate, the treatment release device adapted to be dispensed by the dispenser and to release a pesticide, herbicide, fertilizer, or the like, for adhesion to and treatment of a target plant; and
a quantity of media adapted to contain a controlled release composition disposed upon the substrate and adapted to release the controlled release composition to a target plant for treatment; and
dispensing the controlled release composition from the dispenser to the target plant for treatment.

20. The method of claim 19, further comprising:
utilizing an applicator further comprising:
an adhesive composition disposed upon the substrate and adapted to adhere the treatment release device and the quantity of media adapted to contain a controlled release composition to the target plant for treatment; and
adhering the treatment release device and the quantity of media adapted to contain the controlled release composition to the target plant for treatment.

21. The method of claim 19, wherein the substrate comprises one selected from the group consisting of: a tape adapted to be dispensed from a dispenser and applied to a target plant for treatment, a plurality of pre-cut patches adapted to be dispensed from a dispenser and applied to a target plant for treatment, and a clamshell housing within which the quantity of media adapted to contain a controlled release composition is disposed.
